(19) United States
(12) Patent Application Publication
(10) Pub. No.: US 2026/0311236 A1
(43) Pub. Date: Oct. 8, 2026

(54) DYNAMIC PRODUCT DESIGN VIA GENERATIVE ARCHITECTURES

(71) Applicant: DISNEY ENTERPRISES, INC., Burbank, CA (US)

(72) Inventors: Tatiana Marie VAZ, Los Angeles, CA (US); Malcolm Edward MURDOCK, Santa Clarita, CA (US); Alif S. KHALFAN, Redwood City, CA (US)

(21) Appl. No.: 19/098,876

(22) Filed: Apr. 2, 2025

(51) Int. Cl. G06Q 30/0601; G06Q 30/0201

(52) U.S. Cl. CPC G06Q 30/0631; G06Q 30/0206

(57) ABSTRACT

The present invention sets forth techniques for generating customized product designs. The techniques include generating, via one or more machine learning models based at least on information associated with a user, candidate product data comprising (i) one or more candidate customized product suggestions, (ii) one or more product images corresponding to the one or more candidate customized product suggestions, and (iii) one or more product descriptions for the one or more candidate customized product suggestions. The techniques also include determining, via one or more additional machine learning models based on the candidate product data, at least a subset of the one or more candidate customized product suggestions that meets a set of evaluation criteria, and outputting at least the subset of the one or more candidate customized product suggestions to the user.

### BACKGROUND

### Field of the Various Embodiments

Embodiments of the present disclosure relate generally to machine learning and generative models and, more specifically, to techniques for dynamic product design via generative architectures.

### Description of the Related Art

In the fields of product design and product creation, users may wish to customize the appearance or material of an existing product, rather than limiting their choices to versions of products that have already been designed and/or created. For example, a customer may attempt to search a product website for a coffee mug including one or more personalized or otherwise customized design elements that are not available on pre-designed or already created mugs.

However, multiple manual, human-performed steps are typically performed to create, review, update, approve, and/or manufacture a product with a given design. These manual, labor-intensive steps may limit the number and variety of product designs available to a user.

One existing technique for creating on-demand custom product designs may allow a user to specify a customizable product and select one or more options from a list of available colors, designs, patterns, and/or textual content via, e.g., a custom design page included in a manufacturer's or vendor's website. The manufacturer or vendor then applies the selected options to the specified customizable product and produces the customized product for sale and/or delivery. This technique offers only limited customization via user selection of provided options, and does not allow a user to interactively explore or discover novel custom design elements.

Other existing techniques may allow a user to provide their own design content to be applied to an existing base product. For example, a user may provide one or more images to be combined with a basic calendar design to produce a customized calendar. Similarly, a user may specify a textual phrase to be imprinted upon a towel, apron, or coffee mug. These techniques may be restricted to incorporating the user's design content exactly as provided, or may provide only limited editing capabilities, such as resizing or cropping provided images, or choosing colors and/or fonts associated with a textual phrase. Similar to the above technique, these techniques do not allow the user to create or explore novel custom design elements beyond what is included in the user-provided design content.

Additionally, search results returned in response to a user search for a product with a certain set of attributes may include a limited number of products, products that do not match all of the attributes, and/or products that are not relevant to the (implicit or explicit) preferences of the user. For example, a user may attempt to search a website and/or platform for products that include a combination of characters from different worlds and/or stories. However, because product designs are typically limited to characters that encompass a single world and/or story, the search may return an empty set of search results and/or a non-empty set of search results that does not include the desired combination of characters.

As the foregoing illustrates, what is needed in the art are more effective techniques for creating and surfacing customized product designs.

One embodiment of the present invention sets forth a technique for generating customized product designs. The technique includes generating, via one or more machine learning models based at least on information associated with a user, candidate product data comprising (i) one or more candidate customized product suggestions, (ii) one or more product images corresponding to the one or more candidate customized product suggestions, and (iii) one or more product descriptions for the one or more candidate customized product suggestions. The technique also includes determining, via one or more additional machine learning models based on the candidate product data, at least a subset of the one or more candidate customized product suggestions that meets a set of evaluation criteria. The technique further includes outputting the at least the subset of the one or more candidate customized product suggestions to the user.

One technical advantage of the disclosed techniques relative to the prior art is that the disclosed techniques leverage large language models (LLMs) and/or other generative machine learning models and multiple information types from one or more channels to automate the generation of customized product designs. The information types may include known user preferences, user purchase/viewing histories, the user's geographic location, criteria and/or standards for the customized product designs, and/or multimodal descriptive user input. The disclosed techniques sequentially execute multiple LLMs to both generate product designs and to evaluate the generated product designs, enabling a logical, stepwise progression from a textual input to a finished product design. The disclosed techniques may also iteratively present one or more generated customized product designs to a user for approval and/or feedback. Another technical advantage of the disclosed techniques is that, because customized product designs can be generated, reviewed, updated, approved, and/or made available to end users in an automatic and/or streamlined fashion, products included in search results may be more relevant to search terms and/or user preferences than products that are designed and/or created using conventional manual approaches. A further technical advantage of the disclosed techniques is that the sequential application of multiple individual LLMs allows for human review and/or approval at one or more intermediate stages of automated product design creation. This modular, stagewise configuration enables the automatic generation of product designs, while also providing visibility and oversight to the creation process. These technical advantages provide one or more improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments of the present invention.

FIGS. 2A and 2B are more detailed illustrations of the customization engine of FIG. 1, according to some embodiments.

FIG. 3 is a flow diagram of method steps for customized product generation, according to some embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

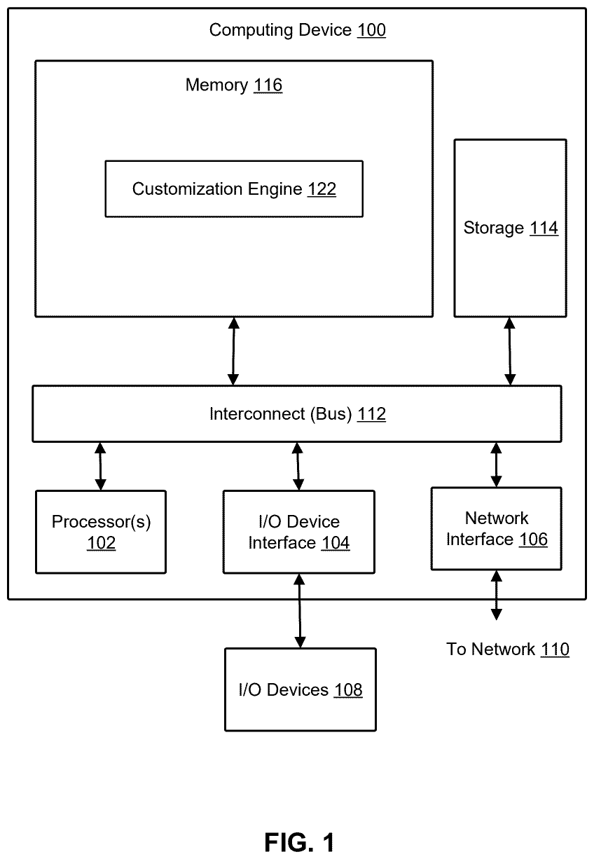

FIG. 1 illustrates a computing device 100 configured to implement one or more aspects of various embodiments of the present invention. In one embodiment, computing device 100 includes a desktop computer, a laptop computer, a smart phone, a personal digital assistant (PDA), tablet computer, Augmented Reality or Mixed Reality headset, or any other type of computing device that is configured to receive input, process data, and optionally display images, and is suitable for practicing one or more embodiments. Computing device 100 is configured to run a customization engine that resides in a memory 116.

It is noted that the computing device described herein is illustrative and that any other technically feasible configurations fall within the scope of the present disclosure. For example, multiple instances of customization engine 122 could execute on a set of nodes in a distributed and/or cloud computing system to implement the functionality of computing device 100. In another example, customization engine 122 could execute on various sets of hardware, types of devices, or environments to adapt customization engine 122 to different use cases or applications. In a third example, customization engine 122 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (Wi-Fi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Customization engine 122 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including customization engine 122.

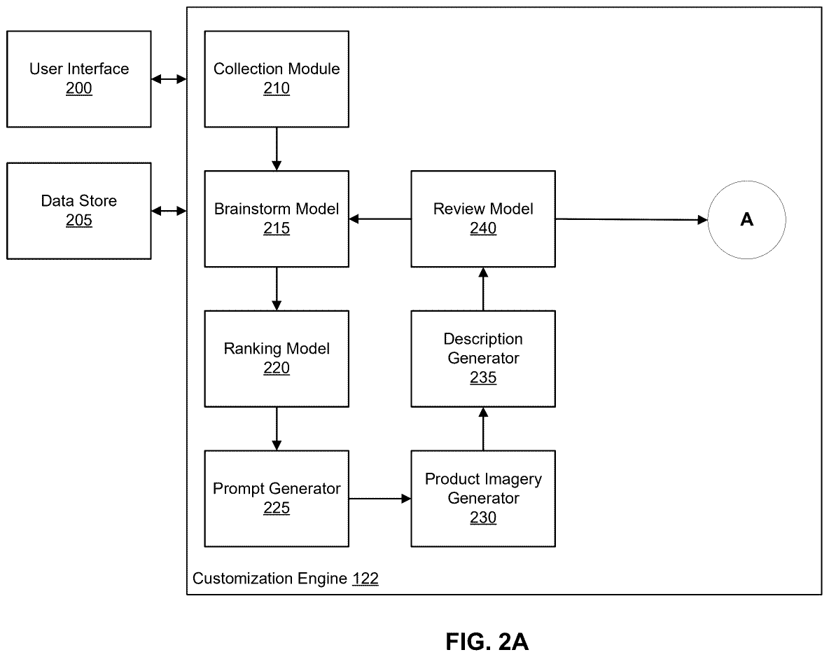

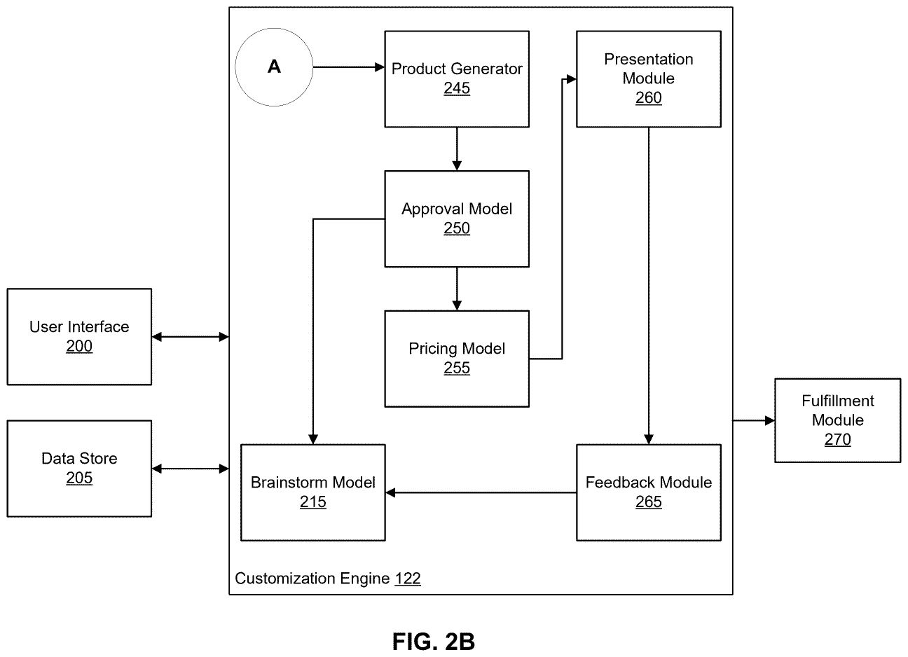

FIGS. 2A and 2B are more detailed illustrations of customization engine 122 of FIG. 1, according to some embodiments. Customization engine 122 generates customized product designs based on user input received via user interface 200 and/or one or more items of information included in data store 205. Customization engine 122 presents one or more of the generated product designs to a user for feedback and/or approval. Customization engine 122 transmits one or more user-approved product designs to fulfillment module 270 for creation. As shown in FIG. 2A, components of customization engine 122 include, but are not limited to, collection module 210, brainstorm model 215, ranking model 220, prompt generator 225, product imagery generator 230, description generator 235, and review model 240. Throughout this disclosure, any recitations of imagery, characters, logos, product listings, or other design elements and assets provided as training data or other input to one or more system components refer to imagery or other content for which the owner or brand has granted permission to use, and which adhere to one or more brand guidelines or brand bibles or brand appropriateness.

In various embodiments, user interface 200 may include a graphical and/or textual user interface enabling a user to search for and/or view one or more existing product offerings, where each product offering may include one or more visual depictions of a product, a textual description associated with the product, and/or a price associated with the product. User interface 200 may also enable a user to provide a description associated with a desired custom product, where the description may include a textual description of the desired custom product and/or one or more references to existing product offerings.

In various embodiments, user interface 200 may reside in a dedicated e-commerce application executing on a point-of-sale (POS) platform, such as a kiosk potentially located in a retail establishment. In other embodiments, user interface 200 may reside in an e-commerce website executing on a web browser or other application resident on a user's personal computing device, such as a mobile telephone, tablet, personal computer, or smart television.

In various embodiments, a user may submit unique identifying information via user interface 200, such as a username and/or password. Associating unique identifying information with a user enables customization engine 122 to track and record user activity within the e-commerce website or application. Customization engine 122 may also retrieve historical user information from data store 205 as described below, based on the unique identifying information. Based on the unique identifying information, user interface 200 may present a customized greeting to the user, where the customized greeting may include the user's name and/or an avatar associated with the user. In various embodiments, the avatar may be customized by the user, or may be related to a brand.

User interface 200 may include a search bar or similar search functionality allowing the user to search for existing product offerings based on one or more of descriptive keywords, free-text descriptions, category selections, and/or filters. User interface 200 may present one or more existing product offerings to the user via the graphical user interface, and allow the user to reorder or further filter the presented product offerings.

User interface 200 may allow the user to initiate the design and creation of a customized product. In various embodiments, user interface 200 may include a button, hyperlink, menu item, or other user interface element associated with customized product creation. Additionally or alternatively, a user may describe a desired customized product by entering a plain language description in the search bar. For example, a user may enter a prompt in the search bar, such as “I would like to design a lunch box with Princess ABC on it.” Upon user selection of the customized product creation user interface element or the entry of a plain language description, user interface 200 transmits one or more of the unique identifying user information and customized product description to collection module 210.

Data store 205 may include user information associated with one or more uniquely identified users. In various embodiments, user information associated with a unique user may include a geographic location or region associated with the user, a history of previous product purchases made by the user, and/or one or more items of media content rented, purchased or viewed by the user via, e.g., one or more media streaming services. Data store 205 may also include one or more favorite or otherwise preferred characters and/media items associated with the user, such as animated or live-action characters, movies, television shows, music, or books. Data store 205 may also include one or more interests associated with the user. In various embodiments, the one or more interests and/or the one or more favorite characters and/or media items may be based on the user's product viewing history, purchase history, one or more products resident in the user's shopping cart, or other historical information associated with the user. Data store 205 may also include one or more products that have recently been viewed by the user via the application and/or website.

Data Store 205 may include product details associated with one or more currently or previously available products, where each product may be uniquely identified by a Stock Keeping Unit (SKU). Product details may include one or more of pictures, textual descriptions, physical dimensions, other specifications, or pricing information associated with the product and/or product packaging. The currently or previously available products may also include customizable products that may be modified based on user information and/or user input.

Data store 205 may further include records associated with the user's historical viewing and/or activity associated with a media streaming service or other media content service. For example, data store 205 may include records associated with TV shows, movies, or other multimedia content that the user has purchased or viewed in the past, including user activity associated with one or more digital media streaming services. Data store 205 may also include records associated with the user's activities at an amusement park or similar attraction, including ticket purchases, previously experienced shows, rides, or other attractions, and/or purchases made while at the amusement park or similar attraction.

Collection module 210 gathers information from one or more of user interface 200 and data store 205 and generates a Large Language Model (LLM) prompt (or other types of input) for brainstorm model 215 described below. In various embodiments, collection module 210 may retrieve a user-generated description of a desired customized product via user interface 200. Collection module 210 may also query data store 205 and retrieve one or more of a geographical location associated with the user, previous purchases associated with the user, one or more favorite or otherwise preferred characters and/or media items associated with the user, one or more interests associated with the user, or one or more products that the user has recently viewed and/or added to the user's shopping cart. In various embodiments, the one or more recently viewed products may include a predetermined number of the most recently viewed products, or all products viewed within a particular time period, such as the prior 30 days or the prior 60 days.

Collection module 210 generates an LLM prompt based on the information received from user interface 200 and/or data store 205. In an instance where collection module 210 receives a user-generated description of a desired customized product via user interface 200, the LLM prompt may include at least the user-generated description. The LLM prompt may also include contextual information associated with the user-generated description, such as one or more of a geographical location associated with the user, previous purchases associated with the user, one or more favorite or otherwise preferred items of media or other content associated with the user, one or more interests associated with the user, or one or more products that the user has recently viewed.

In an instance where collection module 210 does not receive a user-generated description of a desired customized product, collection module 210 may retrieve the same contextual information described above, and may include a generic predetermined request in the LLM prompt, such as “based on the contextual information provided with this prompt, please suggest a customized product suitable for a user associated with the contextual information.” Collection module 210 transmits the LLM prompt to brainstorm model 215, including the contextual information and one or both of the user-generated description of a desired customized product and the generic predetermined request.

Brainstorm model 215 includes a trained LLM (or another type of machine learning model) and generates one or more textual candidate customized product suggestions based on the LLM prompt received from collection module 210. In various embodiments, each of the one or more candidate customized product suggestions includes a customizable product and a description of visual content to be applied to the customizable product. Examples of customizable products may include, but are not limited to, articles of clothing, blankets, bed linens, towels, home and/or kitchen items, mugs, dishes or other glassware, lunch boxes, stationery, calendars, or notebooks. Visual content descriptions may include a textual description of one or more characters, geographic locations, logos, colors, backgrounds, objects, and/or other entities to be depicted in a given customizable product.

In various embodiments, brainstorm model 215 may be previously fine-tuned on a collection including products that are available to a user for customization. Brainstorm model 215 may also be previously fine-tuned on a collection including various depictions of one or more characters, logos, or other design elements. For example, the collection may include one or more depictions of a live-action version of a character, as well as one or more depictions of an animated version of the character. Further, the collection may include different variations of a single animated and/or live-action character, such as variations depicting different poses, actions, facial expressions, or costumes. The different variations may include multiple depictions of a character expressed in multiple different artistic styles, such as minimalist, abstract expressionist, color, black and white, line drawings, or sketches.

Brainstorm model 215 may also be previously fine-tuned on a data set including existing Stock Keeping Units (SKUs), where each SKU is associated with a currently or previously available retail product. Each SKU may include an associated textual description, one or more associated images, and/or a price associated with the retail product. In various embodiments, brainstorm model 215 may also be previously fine-tuned on historical sales data associated with one or more of the SKUs, including total number of sales, total revenue, profit per sale, and/or the current and/or historical popularity of the retail product associated with the SKU.

Based on the LLM prompt, brainstorm model 215 generates one or more candidate customized product suggestions, where each candidate customized product suggestion includes a type of customizable product and a description of visual content to be applied to the customizable product. For example, a candidate customized product suggestion may include a pairing of a coffee mug with a description of one or more characters, a background, other graphical elements, and/or textual elements. In various embodiments, brainstorm model 215 may generate a predetermined number, e.g., tens, hundreds, or thousands, of candidate customized product suggestions. Brainstorm model 215 transmits the one or more candidate customized product suggestions to ranking model 220.

Ranking model 220 may include one or more machine learning models trained to evaluate a candidate customized product suggestion and generate one or more metric values associated with the candidate customized product suggestion. In various embodiments, ranking model 220 may be trained on a data set similar to the data set discussed above in the description of brainstorm model 215, including various depictions of one or more design elements and/or a collection of SKUs and metrics (e.g., sales, profit, pricing, popularity, etc.) associated with each SKU. Ranking model 220 may generate a given metric value associated with a candidate customized product suggestion based on historical metrics for one or more SKUs including imagery similar to the imagery description included in the candidate customized product suggestion. This metric value may represent attributes such as, but not limited to, popularity, relevance, price, and/or profit associated with each candidate customized product suggestion.

Ranking model 220 may generate a final metric value associated with the candidate customized product suggestion, where the final metric value may be based on a (possibly weighted) summation of individual metric values associated with the candidate customized product suggestion. Ranking model 220 may generate additional final metric values for one or more remaining candidate customized product suggestions, and arrange the candidate customized product suggestions based on their associated final metric values. In various embodiments, ranking model 220 may transmit a predetermined number of the candidate customized product suggestions having the highest final metric values (or individual metric values) to prompt generator 225. In other embodiments, ranking model 220 may transmit any number of candidate customized product suggestions having a final metric value (or individual metric value) above a predetermined threshold to prompt generator 225.

Prompt generator 225 receives a candidate customized product suggestion, including a description of imagery associated with the candidate customized product suggestion and a customizable product associated with the candidate customized product suggestion. Prompt generator 225 produces a machine learning prompt for transmittal to product imagery generator 230, based on the imagery description and the customizable product included in the candidate customized product suggestion. For example, the machine learning prompt may instruct product imagery generator 230 to “superimpose the described imagery onto the surface of the provided customizable product, and generate a raster depiction of the customizable object with the superimposed imagery.” Prompt generator 225 transmits the machine learning prompt and the candidate customized product suggestion to product imagery generator 230.

In various embodiments, product imagery generator 230 includes a generative diffusion machine learning model (or another type of machine learning model) that has been previously trained to generate an image based on a textual description, apply the generated image to the surface of a provided object, and generate a two-dimensional raster image depicting the object having the generated image superimposed onto the object's surface. Product imagery generator 230 may be trained on a data set including images and associated imagery descriptions, customizable objects, and depictions of customized objects with applied imagery. Product imagery generator 230 may be further fine-tuned on a data set including multiple depictions of imagery, such as images of characters and/or logos, as well as multiple depictions of specific customizable objects. Product imagery generator 230 transmits the generated raster image of the customized object to description generator 235.

In various embodiments, description generator 235 includes a generative machine learning model that produces a textual description of an object depicted in a provided two-dimensional raster image. Description generator 235 may be previously trained on a dataset including multiple objects and associated descriptions. For example, description generator 235 may be trained on existing SKUs and associated descriptions included in a brand's e-commerce website database. Description generator 235 may further be trained on human-provided textual descriptions associated with synthetically generated raster images. A textual description produced by description generator 235 may include a description of the depicted object itself and a description of elements included in an image superimposed on the depicted object. For example, a textual description may state that the object is “a coffee mug with a picture of Princess ABC wearing a cowboy hat and waving a lasso.” In various embodiments, description generator 235 may retrieve product details associated with the customizable product included in the candidate customized product suggestion from data store 205, such as a product name or type, physical dimensions, a weight, a capacity, a thread count, and/or a basic textual description. Description generator 235 transmits the candidate customized product suggestion, including at least the two-dimensional raster image and the generated textual description to review model 240.

Review model 240 analyzes a candidate customized product suggestion received from description generator 235, including a two-dimensional raster image and a generated textual product description. Review model 240 may include a trained machine learning model that evaluates the candidate customized product suggestion for viability and appropriateness. In various embodiments, review model 240 may be previously fine-tuned on a data set including multiple depictions of brand-approved imagery, such as depictions of characters exhibiting various different expressions, poses, actions, and artistic styles.

Review model 240 may determine that the supplied raster image is not viable, as it does not fit properly on the surface of the customizable product and needs to be resized and/or re-oriented to avoid cutting off, e.g., a character's head and/or limbs. Review model 240 may also determine that the appearance of a character or object is not appropriate, based on the corpus of imagery on which review model 240 has been previously trained. For example, review model 240 may determine that a depicted character includes flaws, such as extra or missing limbs, incorrect proportions, and/or improper colors and/or textures. Review model 240 may also determine that a textual product description included in a candidate customized product suggestion is inappropriate, based on product descriptions associated with SKUs included in a data set used to train review model 240. A textual product description included in a candidate customized product suggestion may misidentify a character depicted in the raster image, or may include incompatible characteristics associated with a customizable object. For example, review model 240 may determine that a textual product description of a coffee mug incorrectly includes a thread count or other description of a fabric material.

In an instance where review model 240 determines that the supplied raster image is both viable and appropriate, review model 240 transmits the candidate customized product suggestion to product generator 245, discussed below in the detailed description of FIG. 2B. Drawing element ‘A’ in FIGS. 2A and 2B represents a connection between those components of customization engine 122 depicted in FIG. 2A and those components of customization engine 122 depicted in FIG. 2B.

In an instance where review model 240 determines that the supplied raster image is not viable or not appropriate, review model 240 transmits the candidate customized product suggestion to brainstorm model 215, as well as associated feedback including a description of the determined flaws and/or reasons that the imagery and/or description is not viable and/or appropriate. Customization engine 122 may further fine-tune brainstorm model 215 based on the candidate customized product suggestion and associated feedback.

As shown in FIG. 2B, additional components of customization engine 122 include, but are not limited to, product generator 245, approval model 250, pricing model 255, presentation module 260, and feedback module 265.

In various embodiments, product generator 245 may include a generative diffusion model (or another type of machine learning model), previously trained on a data set including multiple SKUs associated with existing products. Each SKU may include an associated product listing depicting the presentation of a product as it might appear on, e.g., a retail website. Product generator 245 receives a candidate customized product suggestion, one or more images, and a product description from review model 240, and generates a product listing associated with the candidate customized product suggestion. In various embodiments, the product listing may include, but is not limited to, one or more 2D images of a customized product, a three-dimensional (3D) representation of the customized product, a short video clip representing the customized product, images depicting a box or other container associated with the customized product, images depicting packaging material associated with the customized product, and/or a textual description of the product. Product generator 245 transmits the product listing to approval model 250.

In various embodiments, approval model 250 includes a previously trained multimodal large language model (MLLM). Approval model 250 analyzes depictions and/or descriptions of characters and/or other assets included in a product listing received from product generator 245, and determines whether the depictions and/or descriptions are consistent with predetermined brand guidelines associated with the characters and/or other assets.

In various embodiments, approval model 250 may be previously trained on one or more character bibles, where each character bible is associated with a particular character. Each of the one or more character bibles may include a description of a character, and descriptions of one or more worlds or other environments associated with the character, such as an underwater environment, an urban environment, or a spaceship. Each character bible may also specify actions that the character may or may not take, different characters that the character may or may not interact with, and/or facial expressions that are either appropriate or inappropriate for the character. For example, a character bible associated with one character may specify that the associated character never smokes, while a character bible associated with a different character may specify that the different character is frequently depicted smoking a cigar. Similarly, a character bible may specify one or more different characters with whom a particular character is frequently associated, or one or more characters with whom the particular character would not associate. In various embodiments, approval model 250 may also be previously trained on a data set including multiple existing, previously approved product listings, where each product listing is uniquely identified by a SKU and includes a visual depiction of one or more characters depicted on the product and/or a textual description of a product included in the product listing. In various embodiments, approval model 250 may include the same machine learning model(s) as those included in review model 240. In other embodiments, approval model 250 may include additional instances or copies of the machine learning model(s) included in review model 240, and/or one or more machine learning models that are different from those machine learning models included in review model 240.

Customization engine 122 may generate a prompt for submission to approval model 250, where the prompt directs approval model 250 to evaluate the product listing generated by product generator 245 for brand appropriateness. Approval model 250 may evaluate the generated product listing based on the previously learned brand guidelines included in the various character bibles and previously approved SKUs included in the training data set. Approval model 250 may produce an evaluation stating that the generated product listing is “appropriate” or “not appropriate.” In various embodiments, approval model 250 may also generate supporting information associated with the evaluation, such as one or more portions included in a character bible that support an evaluation of “not appropriate,” or portions of one or more previously approved SKUs that support an evaluation of “appropriate.”

In an instance where approval model 250 evaluates a generated product listing as “not appropriate,” approval model 250 may transmit the generated product listing, the evaluation, and one or more items of supporting information to brainstorm model 215. Customization engine 122 may fine-tune brainstorm model 215 based on the generated product listing, the evaluation, and/or the supporting information. In various embodiments, customization engine 122 may fine-tune brainstorm model 215 each time that approval model 250 generates an evaluation of “not appropriate.” In other embodiments, customization engine 122 may fine-tune brainstorm model 215 after approval model 250 generates a predetermined number of “not appropriate” evaluations, or upon direction from an administrator.

In an instance where approval model 250 evaluates a generated product listing as “appropriate,” approval model 250 transmits the generated product listing to pricing model 255. Customization engine 122 may generate a prompt directing pricing model 255 to estimate a price associated with the generated product listing. Customization engine 122 may also fine-tune brainstorm model 215 based on a generated product listing that is evaluated as “appropriate,” either immediately after the evaluation, after a predetermined number of “appropriate” evaluations, or upon direction from an administrator.

In various embodiments, pricing model 255 may include a previously trained LLM, MLLM, and/or another type of machine learning model that analyzes product images and/or product descriptions included in a generated product listing and generates an estimated price associated with the generated product listing. In various embodiments, pricing model 255 may be trained on a collection of pre-existing product listings, where each pre-existing product listing includes at least imagery depicting a product, a textual description of the product, and a price associated with the product. Each pre-existing product listing may also include a list of material types and quantities associated with the product, or one or more physical measurements associated with the product, size as height, weight, or capacity. Each pre-existing product listing may further include a description of a box, other container, and/or packing material associated with the product. In various embodiments, each pre-existing product listing may include additional product information, such as a manufacturer associated with the product, or licensing fees associated with one or more design elements depicted in the product.

Pricing model 255 receives a generated product listing from approval model 250 and/or a prompt generated by customization engine 122. For example, the prompt may direct pricing model 255 to “estimate a retail price associated with the supplied product listing, taking into account what you know about retail prices associated with product listings that include similar customizable objects, materials, and imagery.” Pricing model 255 generates an estimated retail price and associates the estimated retail price with the generated product listing. Pricing model 255 transmits the generated product listing and the associated estimated retail price to presentation module 260.

Presentation module 260 receives the generated product listing and estimated retail price, and formats the generated product listing and estimated retail price for display to a user via user interface 200. For example, if a user is interacting with a kiosk in a retail establishment, presentation module 260 may format the generated product listing and estimated retail price to exhibit the same format and appearance as other product listings displayed to the user via the kiosk. In a similar manner, presentation module 260 may format the generated product listing and estimated retail price to match the appearance of a retail website executing on the user's web browser. Presentation module 260 provides a consistent shopping experience for the user, allowing the user to view the generated product listing as if it were just another product available for purchase.

In various embodiments, presentation module 260 may prompt the user as to whether the user is satisfied with the generated product listing and wishes to purchase the customized object for the estimated retail price. In an instance where the user is not satisfied with the generated product listing, presentation module 260 may prompt the user for feedback, and transmit the feedback, the generated product listing, and the estimated retail price to brainstorm model 215. Customization engine 122 may initiate a new customization process based on the received feedback, the generated product listing, and the estimated retail price, and present a modified generated product listing to the user via presentation module 260. For example, the user may submit feedback stating that a character should appear larger on the customized product, and/or that one or more characters should be removed from the customized product. The user may also state that the estimated retail price is too high, and that the user would like to view cheaper alternatives. In various embodiments, customization engine 122 may present alternatives to the user via presentation module 260 based on the user feedback, such as suggesting a smaller or larger version of the customizable product, or suggesting a different customizable product, such as substituting a coffee mug in place of a stainless-steel tumbler. Customization engine 122 may transmit user responses to these suggestions to brainstorm model 215 to further refine future candidate customized product designs.

In an instance where the user is satisfied with the generated product listing, customization engine 122 may further fine-tune one or more of the machine learning models included in customization engine 122, based on one or more elements included in the generated product listing. For example, customization engine 122 may fine-tune description generator 235 based on the user's positive feedback, product imagery and product description included in the generated product listing. Similarly, customization engine 122 may fine-tune product imagery generator 230 based on the user's positive feedback and imagery included in the generated product listing. Customization engine 122 may transmit the generated product listing to fulfillment module 270.

In various embodiments, fulfillment module 270 may automatically collect payment from the user and transmit the generated product listing to a retailer or manufacturer for production and subsequent delivery to the user. In other embodiments, fulfillment module 270 may inform the user that the generated product listing will be submitted to the retailer and/or manufacturer for final approval and/or pricing verification, and that the user will be updated with finalized approval and/or pricing information. Fulfillment module 270 may also add a generated product listing to an existing inventory, making the generated product listing available to other users in the future.

In various embodiments, customization engine 122 may include a “human in the loop” while performing one or more customization steps. For example, customization engine 122 may present one or more candidate customized product suggestions generated by brainstorm model 215 to a human supervisor for review, modification, and/or approval before transmitting the candidate customized product suggestions to ranking model 220. Customization engine 122 may also present one or more generated machine learning model prompts to a human supervisor for review prior to transmitting the one or more prompts to their respective machine learning models. The human supervisor may also review the evaluation of a generated product listing by approval model 250 prior to presenting the generated product listing to the user. As described above, fulfillment module 270 may include a human-supervised final approval of a generated product listing and/or an estimated retail price associated with the product listing.

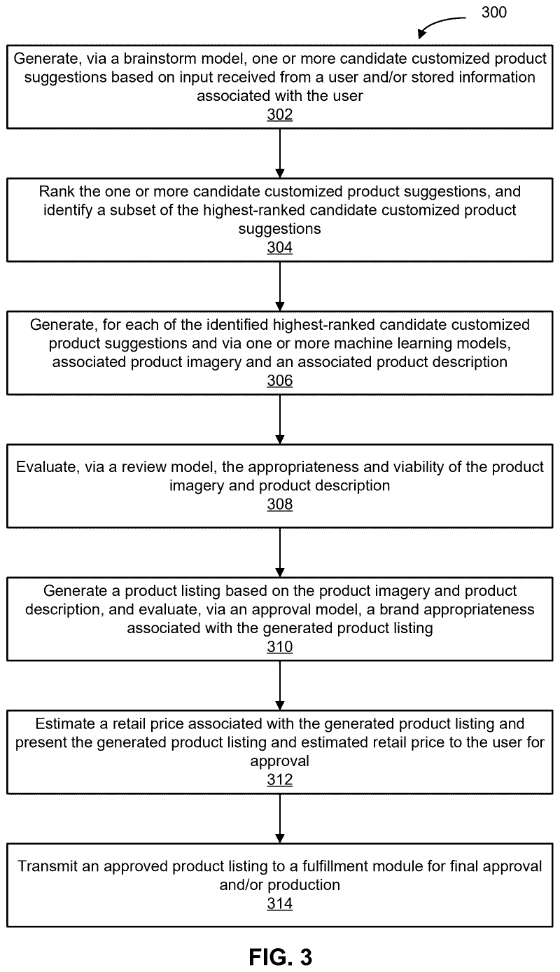

FIG. 3 is a flow diagram of method steps for customized product generation, according to some embodiments. Although the method steps are described in conjunction with the systems of FIGS. 1, 2A, and 2B, persons skilled in the art will understand that any system configured to perform the method steps in any order falls within the scope of the present disclosure.

As shown, in step 302 of method 300, brainstorm model 215 of customization engine 122 generates one or more candidate customized product suggestions based on input received from a user via user interface 200 and/or stored information included in data store 205. User interface 200 may include a graphical and/or textual user interface enabling a user to search for and/or view one or more existing product offerings. User interface 200 may also enable a user to provide a description associated with a desired custom product, where the description may include a textual description of the desired custom product and/or one or more references to existing product offerings.

In various embodiments, a user may submit unique identifying information via user interface 200, such as a username and/or password. Associating unique identifying information with a user enables customization engine 122 to track and record user activity within the e-commerce website or application. Customization engine 122 may also retrieve historical user information from data store 205 as described below, based on the unique identifying information. Based on the unique identifying information, user interface 200 may present a customized greeting to the user, where the customized greeting may include the user's name and/or one or more brand elements associated with the user, such as a movie or television character associated with the user's previous browsing, searching, and/or purchase history.

User interface 200 may allow the user to initiate the design and creation of a customized product. In various embodiments, user interface 200 may include a button, hyperlink, menu item, or other user interface element associated with customized product creation. Additionally or alternatively, a user may describe a desired customized product by entering a plain language description in the search bar. Upon user selection of the customized product creation user interface element or the entry of a plain language description, user interface 200 transmits one or more of the unique identifying user information and customized product description to collection module 210.

Data store 205 may include user information associated with one or more uniquely identified users. In various embodiments, user information associated with a unique user may include a geographic location or region associated with the user, a history of previous product purchases made by the user, and/or one or more items of media content rented, purchased or viewed by the user via, e.g., one or more media streaming services. Data store 205 may also include one or more favorite or otherwise preferred characters and/or media items, such as animated or live-action characters, movies, television shows, music, or books. Data store 205 may also include one or more interests associated with the user. In various embodiments, the one or more interests and/or the one or more favorite characters and/or media items may be based on the user's product viewing history, purchase history, one or more products resident in the user's shopping cart, or other historical information associated with the user. Data store 205 may also include one or more products that have recently been viewed by the user via the e-commerce application and/or website.

Data store 205 may further include records associated with the user's historical viewing and/or activity associated with a media streaming service or other media content service. For example, data store 205 may include records associated with TV shows, movies, video clips, and/or trailers that the user has purchased or viewed in the past. Data store 205 may also include records associated with the user's activities at an amusement park or similar attraction, including ticket purchases, previously experienced shows, rides, or other attractions, and/or purchases made while at the amusement park or similar attraction. Data store 205 may also include information shared by a user, such as hobbies, birthdates, anniversary dates, or nicknames.

Collection module 210 gathers information from one or more of user interface 200 and data store 205 and generates a Large Language Model (LLM) prompt for brainstorm model 215 described below. In various embodiments, collection module 210 may retrieve a user-generated description of a desired customized product via user interface 200. Collection module 210 may also query data store 205 and retrieve one or more of a geographical location associated with the user, previous purchases associated with the user, one or more favorite or otherwise preferred characters and/or media items associated with the user, one or more interests associated with the user, or one or more products that the user has recently viewed and/or added to the user's shopping cart.

Collection module 210 generates an LLM prompt based on the information received from user interface 200 and/or data store 205. In an instance where collection module 210 receives a user-generated description of a desired customized product via user interface 200, the LLM prompt may include at least the user-generated description. The LLM prompt may also include contextual information associated with the user-generated description, such as one or more of a geographical location associated with the user, previous purchases associated with the user, one or more favorite or otherwise preferred characters and/or media items associated with the user, one or more interests associated with the user, or one or more products that the user has recently viewed.

In an instance where collection module 210 does not receive a user-generated description of a desired customized product, collection module 210 may retrieve the same contextual information described above, and may include a generic predetermined request in the LLM prompt, such as “based on the contextual information provided with this prompt, please suggest a customized product suitable for a user associated with the contextual information.” Collection module 210 transmits the LLM prompt to brainstorm model 215, including the contextual information and one or both of the user-generated description of a desired customized product and the generic predetermined request.

Brainstorm model 215 includes a trained LLM and generates one or more textual candidate customized product suggestions based on the LLM prompt received from collection module 210. In various embodiments, each of the one or more candidate customized product suggestions includes a customizable product and a description of visual content to be applied to the customizable product. For example, a candidate customized product suggestion may include a pairing of a coffee mug with a description of one or more characters, a background, other graphical elements, and/or textual elements. In various embodiments, brainstorm model 215 may generate a predetermined number, e.g., tens, hundreds, or thousands, of candidate customized product suggestions. Brainstorm model 215 transmits the one or more candidate customized product suggestions to ranking model 220.

In step 304, ranking model 220 of customization engine 122 ranks the one or more candidate customized product suggestions, and identifies a subset of the highest-ranked candidate customized product suggestions. Ranking model 220 may include one or more machine learning models trained to evaluate a candidate customized product suggestion and generate one or more metric values associated with the candidate customized product suggestion. In various embodiments, ranking model 220 may be trained on a data set similar to the data set discussed above in the description of brainstorm model 215, including various depictions of one or more design elements and/or a collection of SKUs and associated sales, profit, pricing, and/or popularity data associated with each SKU. Ranking model 220 may generate a profit metric value associated with a candidate customized product suggestion based on the historical profitability of one or more SKUs including imagery similar to the imagery description included in the candidate customized product suggestion. Ranking model 220 may also generate popularity, relevance, and/or price metrics associated with each candidate customized product suggestion.

Ranking model 220 may generate a final metric value associated with the candidate customized product suggestion, where the final metric value may be based on a (possibly weighted) summation of individual metric values associated with the candidate customized product suggestion. Ranking model 220 may generate additional final metric values for one or more remaining candidate customized product suggestions, and arrange the candidate customized product suggestions based on their associated final metric values. In various embodiments, ranking model 220 may transmit a subset including a predetermined number of the candidate customized product suggestions having the highest final metric values to prompt generator 225. In other embodiments, ranking model 220 may transmit a subset including any number of candidate customized product suggestions having a final metric value above a predetermined threshold to prompt generator 225.

In step 306, product imagery generator 230 and description generator 235 of customization engine 122 may generate associated product imagery and an associated product description, respectively, associated with each of the identified highest-ranked candidate customized product suggestions. Prompt generator 225 receives a candidate customized product suggestion, including a description of imagery associated with the candidate customized product suggestion and a customizable product associated with the candidate customized product suggestion. Prompt generator 225 produces a machine learning prompt for transmittal to product imagery generator 230, based on the imagery description and the customizable product included in the candidate customized product suggestion. Prompt generator 225 transmits the machine learning prompt and the candidate customized product suggestion to product imagery generator 230.

In various embodiments, product imagery generator 230 includes a generative diffusion machine learning model that has been previously trained to generate an image based on a textual description, apply the generated image to the surface of a provided object, and generate a two-dimensional raster image depicting the object having the generated image superimposed onto the object's surface. Product imagery generator 230 may be trained on a data set including images and associated imagery descriptions, customizable objects, and depictions of customized objects with applied imagery. Product imagery generator 230 may be further fine-tuned on a data set including multiple depiction of brand imagery, such as images of characters and/or logos, as well as multiple depictions of specific customizable objects. Product imagery generator 230 transmits the generated raster image of the customized object to description generator 235.

In various embodiments, description generator 235 includes a generative machine learning model that produces a textual description of an object depicted in a provided two-dimensional (2D) raster image. Description generator 235 may be previously trained on a dataset including multiple objects and associated descriptions. For example, description generator 235 may be trained on existing Store Keeping Units (SKUs) and associated descriptions included in an e-commerce website database. Description generator 235 may further be trained on human-provided textual descriptions associated with synthetically generated 2D images. A textual description produced by description generator 235 may include a description of the depicted object itself and a description of elements included in an image superimposed on the depicted object. In various embodiments, description generator 235 may retrieve product details associated with the customizable product included in the candidate customized product suggestion from data store 205, such as a product name or type, physical dimensions, a weight, a capacity, a thread count, and/or a basic textual description. Description generator 235 transmits the candidate customized product suggestion, including at least the two-dimensional image and the generated textual description to review model 240.

In step 308, review model 240 of customization engine 122 evaluates the appropriateness and/or viability of the generated product imagery and product description. In various embodiments, review model 240 may be previously fine-tuned on a data set including multiple images, such as depictions of characters exhibiting various different expressions, poses, actions, and artistic styles.

Review model 240 may determine that the supplied raster image is not viable, as it does not fit properly on the surface of the customizable product and needs to be resized and/or re-oriented to avoid cutting off, e.g., a character's head and/or limbs. Review model 240 may also determine that the appearance of a character or object is not appropriate, based on the corpus of imagery on which review model 240 has been previously trained. For example, review model 240 may determine that a depicted character includes flaws, such as extra or missing limbs, incorrect proportions, and/or improper colors and/or textures. Review model 240 may also determine that a textual product description included in a candidate customized product suggestion is inappropriate, based on product descriptions associated with SKUs included in a data set used to train review model 240. A textual product description included in a candidate customized product suggestion may misidentify a character depicted in the raster image, or may include incompatible characteristics associated with a customizable object. For example, review model 240 may determine that a textual product description of a coffee mug incorrectly includes a thread count or other description of a fabric material.

In an instance where review model 240 determines that the supplied raster image is both viable and appropriate, review model 240 transmits the candidate customized product suggestion to product generator 245. Customization engine 122 may also fine-tune brainstorm model 215 based on the positive review determination and the supplied raster image.

In an instance where review model 240 determines that the supplied raster image is not viable or not appropriate, review model 240 transmits the candidate customized product suggestion to brainstorm model 215, as well as associated feedback including a description of the determined flaws and/or reasons that the imagery and/or description is not viable and/or appropriate. Customization engine 122 may further fine-tune brainstorm model 215 based on the candidate customized product suggestion and associated feedback.

In step 310, product generator 245 of customization engine 122 generates a product listing based on the generated product listing and/or generated product description received from review model 240. Approval model 250 of customization engine 122 may evaluate a brand appropriateness associated with the generated product listing, based on brand-specific guidelines.

Product generator 245 may include a generative diffusion model, previously trained on a data set including multiple SKUs associated with existing products each depicting one or more design elements. Each SKU may include an associated product listing depicting the presentation of a product as it might appear on, e.g., a retail website or a kiosk located in a retail store. Product generator 245 receives a candidate customized product suggestion, one or more images, and a product description from review model 240, and generates a product listing associated with the candidate customized product suggestion. In various embodiments, the product listing may include, but is not limited to, one or more 2D images of a customized product, a three-dimensional (3D) representation of the customized product, a short video clip representing the customized product, images depicting a box or other container associated with the customized product, images depicting packaging material associated with the customized product, and/or a textual description of the product. Product generator 245 transmits the generated product listing to approval model 250.

In various embodiments, approval model 250 includes a previously trained multimodal large language model (MLLM). Approval model 250 analyzes depictions and/or descriptions of design elements included in a generated product listing received from product generator 245, and determines whether the depictions and/or descriptions are consistent with predetermined brand guidelines associated with the design elements.

In various embodiments, approval model 250 may be previously trained on one or more character bibles, where each character bible is associated with a specific character. Each of the one or more character bibles may include a description of the character, and descriptions of one or more worlds or other environments associated with the character, such as an underwater environment, an urban environment, or a spaceship. Each character bible may also specify actions that the character may or may not take, different characters that the character may or may not interact with, and/or facial expressions that are either appropriate or inappropriate for the character. A character bible may also specify one or more different characters with whom a particular character is frequently associated, or one or more characters with whom the particular character would not associate. In various embodiments, approval model 250 may also be previously trained on a data set including multiple existing, previously approved product listings, where each product listing is uniquely identified by a SKU and includes a visual depiction of one or more characters depicted on the product and/or a textual description of a product included in the product listing.

Customization engine 122 may generate a prompt for submission to approval model 250, where the prompt directs approval model 250 to evaluate the product listing generated by product generator 245 for brand appropriateness. Approval model 250 may evaluate the generated product listing based on the previously learned brand guidelines included in the various character bibles and previously approved SKUs included in the training data set. Approval model 250 may produce an evaluation stating that the generated product listing is “appropriate” or “not appropriate.” In various embodiments, approval model 250 may also generate supporting information associated with the evaluation, such as one or more portions included in a character bible that support an evaluation of “not appropriate,” or portions of one or more previously approved SKUs that support an evaluation of “appropriate.”

In an instance where approval model 250 evaluates a generated product listing as “not appropriate,” approval model 250 may transmit the generated product listing, the evaluation, and one or more items of supporting information to brainstorm model 215. Customization engine 122 may fine-tune brainstorm model 215 based on the generated product listing, the evaluation, and/or the supporting information. In various embodiments, customization engine 122 may fine-tune brainstorm model 215 each time that approval model 250 generates an evaluation of “not appropriate.” In other embodiments, customization engine 122 may fine-tune brainstorm model 215 after approval model 250 generates a predetermined number of “not appropriate” evaluations, or upon direction from an administrator.

In an instance where approval model 250 evaluates a generated product listing as “appropriate,” approval model 250 transmits the generated product listing to pricing model 255. Customization engine 122 may generate a prompt directing pricing model 255 to estimate a price associated with the generated product listing. Customization engine 122 may also fine-tune brainstorm model 215 based on the approval and the generated product listing.

In step 312, pricing model 255 estimates a retail price associated with a generated product listing. Presentation module 260 may present the generated product listing and the estimated retail price to the user for approval via user interface 200.

Pricing model 255 of customization engine 122 may include a previously trained large language model that analyzes product images and/or product descriptions included in a generated product listing and generates an estimated price associated with the generated product listing. Pricing model 255 receives a generated product listing from approval model 250, and a prompt generated by customization engine 122. For example, the prompt may direct pricing model 255 to “estimate a retail price associated with the supplied product listing, taking into account what you know about retail prices associated with product listings that include similar customizable objects, materials, and imagery.” Pricing model 255 generates an estimated retail price and associates the estimated retail price with the generated product listing. Pricing model 255 transmits the generated product listing and the associated estimated retail price to presentation module 260.

Presentation module 260 of customization engine 122 receives the generated product listing and estimated retail price, and formats the generated product listing and estimated retail price for display to a user via user interface 200. Presentation module 260 provides a consistent shopping experience for the user, allowing the user to view the generated product listing as if it were simply another product available for purchase via a retail kiosk or retail website.

In various embodiments, presentation module 260 may prompt the user as to whether the user is satisfied with the generated product listing and wishes to purchase the customized object for the estimated retail price. In an instance where the user is not satisfied with the generated product listing, presentation module 260 may prompt the user for feedback, and transmit the feedback, the generated product listing, and the estimated retail price to brainstorm model 215. Customization engine 122 may initiate a new customization process based on the received feedback, the generated product listing, and the estimated retail price, and present a modified generated product listing to the user via presentation module 260. For example, the user may submit feedback stating that a character should appear larger on the customized product, and/or that one or more characters should be removed from the customized product. The user may also state that the estimated retail price is too high, and that the user would like to view cheaper alternatives. In various embodiments, customization engine 122 may present alternatives to the user via presentation module 260 based on the user feedback, such as suggesting a smaller or larger version of the customizable product, or suggesting a different customizable product, such as substituting a coffee mug in place of a stainless-steel tumbler. Customization engine 122 may transmit user responses to these suggestions to brainstorm model 215 to further refine additional candidate customized product designs for presentation to the user.

In step 314, customization engine 122 transmits a user-approved product listing to fulfillment module 270 for final approval and/or production. In various embodiments, fulfillment module 270 may automatically collect payment from the user and transmit the generated product listing to a retailer or manufacturer for production and subsequent delivery to the user. In other embodiments, fulfillment module 270 may inform the user that the generated product listing will be submitted to the retailer and/or manufacturer for final approval and/or pricing verification, and that the user will be updated with finalized approval and/or pricing information. Fulfillment module 270 may also add a generated product listing to an existing inventory, making the generated product listing available to other users in the future.

In sum, the disclosed techniques receive a product customization request and/or a product search query from a user. The disclosed techniques employ one or more machine learning models to analyze the request/query and contextual information, such as user location, previous user purchase history, previous user viewing history associated with one or more media content items, and one or more items that the user previously viewed or added to a shopping cart, wish list, or similar product repository. The disclosed techniques generate one or more candidate customized product designs, and determine, based on one or more brand guidelines, whether visual and/or content included in the one or more candidate customized product designs is appropriate for production. The disclosed techniques may generate product listings associated with each of the candidate customized product designs and iteratively present one or more of the generated product listings to the user for approval and/or feedback. The disclosed techniques further estimate a product cost associated with a generated product listing, based on, e.g., product materials, material quantities, licensing costs, and/or manufacturing costs associated with printing, assembly, and/or packaging. The disclosed techniques may then transmit a user-approved product listing to a fulfillment module for final approval by a human supervisor and/or production of the customized product associated with the product listing.

In operation, a customization engine receives a product customization request and/or a product search query from a uniquely-identified user via a user interface, such as a kiosk in a retail shop or a retail website executing on the user's web browser. The product customization request may include a user-provided description of a desired customizable product, such as a coffee mug depicting a particular design element, such as a logo or a character. A product search query may include a textual or multimodal description of a desired product, with or without an associated explicit product customization request.

The customization engine gathers information associated with the product customization request or product search query, including the user-provided description, if available, and one or more items of information associated with the user and resident in a data store. For example, the data store may include information associated with the user's geographic location, previous purchases, preferred character and/or media items, interests, recently viewed products, and/or products that the user has previously placed in a shopping cart or a wish list.

Based on the information associated with the product customization request or product search query, the customization engine generates a machine learning prompt for a brainstorm model. The brainstorm model includes a previously trained and fine-tuned machine learning model and generates one or more candidate customized product suggestions based on the machine learning prompt. The brainstorm model may generate hundreds or thousands of candidate customized product suggestions, where each candidate customized product suggestion includes at least a description of a customizable object and a description of one or more design elements. For instance, a candidate customized product suggestion may include a description specifying a blanket that is to be modified with a depiction of a particular character.

The customization engine ranks the one or more candidate customized product selections and identifies a subset of the candidate customized product selections for further processing. The customization engine may evaluate the candidate customized product selections based on current and/or historical criteria included in the data store, including profitability, total sales volume, popularity, topicality, and/or relevance within a particular geographic region. The customization engine may generate individual metric values associated with each criterion, and may also generate a final metric value based on a (possibly weighted) combination of individual metric values. The customization engine may identify a subset of the candidate customized product selections, where the subset includes a predetermined number of candidate customized product selections having the highest final metric values. Alternatively, the customization engine may identify a subset of the candidate customized product selections having final metric values above a predetermined threshold.

For each candidate customized product selection included in the identified subset of candidate customized product selections, the customization engine generates a machine learning prompt. The machine learning prompt directs a generative machine learning model to generate two-dimensional (2D) imagery depicting the customizable object included in the candidate customized product selection as modified with the one or more design elements included in the candidate customized product selection.

The customization engine transmits each candidate customized product selection and the associated generated 2D imagery to a machine learning model that has been previously trained to generate a textual description based on one or more 2D images. The generated textual description includes a description of the customizable object and the one or more design elements included in the 2D imagery. The generated textual description exhibits a similar style and format as descriptions associated with one or more existing products displayed on a retail kiosk or website.

A review model included in the customization engine evaluates the generated imagery and descriptions and determines whether the descriptions and/or imagery are viable and appropriate. The review model may be previously trained on a data set including multiple examples of design elements, as well as a data set including multiple Store Keeping Units (SKUs), where each SKU includes descriptions and imagery associated with an existing product. The review model may determine that generated imagery does not fit properly on the specified customizable object, or that the imagery includes one or more visual flaws, such as missing/extra limbs, improper colors, improper textures, or incorrect clothing. The review model may further determine that a generated description is inaccurate, such as a description of a coffee mug that instead includes specifications associated with an article of clothing. If the review model determines that the candidate customized product selection is not viable or appropriate, the customization engine may may transmit the candidate customized product selection and feedback describing flaws and/or inaccuracies to the brainstorm model. The customization engine may further fine-tune the brainstorm model based on the candidate customized product selection and the feedback.

If the review model evaluates the generated imagery and descriptions to be viable and appropriate, the customization engine generates a product listing based on the generated imagery and descriptions. A product generator includes a machine learning model that has been previously trained to generate a product listing including one or more of 2D images of a customized product, 3D images of the customized product, a short video clip depicting the customized product, or images depicting a box and/or packing material associated with the customized product. The generated product listing exhibits the same formatting and style as existing products offered for sale on a retail kiosk or retail website.

An approval model included in the customization engine evaluates the generated product listing based on one or more brand-specific appropriateness guidelines. The approval model may be previously trained on a data set including one or more character bibles, where each character bible is associated with a specific character. Each character bible may include a description of the character, and descriptions of one or more worlds or other environments associated with the character, such as an underwater environment, an urban environment, or a spaceship. Each character bible may also specify actions that the character may or may not take, different characters that the character may or may not interact with, and/or facial expressions that are either appropriate or inappropriate for the character. A character bible may also specify one or more different characters with whom a particular character is frequently associated, or one or more characters with whom the particular character would not associate. In various embodiments, the approval model may also be previously trained on a data set including multiple existing, previously approved product listings, where each product listing is uniquely identified by a store keeping unit (SKU) and includes a visual representation of one or more characters depicted on the product and/or a textual description of a product included in the product listing.

The approval model may evaluate the generated product listing based on the previously learned guidelines included in the various character bibles and previously approved SKUs included in the training data set. The approval model may produce an evaluation stating that the generated product listing is “appropriate” or “not appropriate.” In various embodiments, the approval model may also generate supporting information associated with the evaluation, such as one or more portions included in a character bible that support an evaluation of “not appropriate,” or portions of one or more previously approved SKUs that support an evaluation of “appropriate.”

The approval model may transmit the generated product listing, the evaluation, and one or more items of supporting information to the brainstorm model. The customization engine may fine-tune the brainstorm model based on the generated product listing, the evaluation, and/or the supporting information.

In an instance where the approval model evaluates a generated product listing as “appropriate,” the customization engine transmits the generated product listing to a pricing model. The customization engine may generate a prompt directing the pricing model to estimate a price associated with the generated product listing. The pricing model may include a previously trained large language model that analyzes product images and/or product descriptions included in a generated product listing and generates an estimated price associated with the generated product listing. The pricing model may be trained on a collection of pre-existing product listings, where each pre-existing product listing includes at least imagery depicting a product, a textual description of the product, and a price associated with the product. Each pre-existing product listing may also include a list of material types and quantities associated with the product, or one or more physical measurements associated with the product, size as height, weight, or capacity. Each pre-existing product listing may further include a description of a box, other container, and/or packing material associated with the product. Each pre-existing product listing may include additional product information, such as a manufacturer associated with the product, or licensing fees associated with one or more elements depicted in the product.

The pricing model receives a generated product listing from the approval model, and a prompt generated by the customization engine. For example, the prompt may direct the pricing model to “estimate a retail price associated with the supplied product listing, taking into account what you know about retail prices associated with product listings that include similar customizable objects, materials, and imagery.” The pricing model generates an estimated retail price and associates the estimated retail price with the generated product listing. The pricing model transmits the generated product listing and the associated estimated retail price to a presentation module for display to the user.

The presentation module formats the generated product listing and estimated retail price for display to a user via a user interface. The presentation module may prompt the user as to whether the user is satisfied with the generated product listing and wishes to purchase the customized object for the estimated retail price. In an instance where the user is not satisfied with the generated product listing, the presentation module may prompt the user for feedback, and transmit the feedback, the generated product listing, and the estimated retail price to the brainstorm model. The customization engine may initiate a new customization process based on the received feedback, the generated product listing, and the estimated retail price, and present a modified generated product listing to the user via the presentation module.

If the user is satisfied with the generated product listing, the customization engine may transmit the generated product listing to a fulfillment module. The fulfillment module may automatically collect payment from the user and transmit the generated product listing to a retailer or manufacturer for production and subsequent delivery to the user. Alternatively, the fulfillment module may inform the user that the generated product listing will be submitted to the retailer and/or manufacturer for final approval and/or pricing verification. The fulfillment module may also add a generated product listing to an existing inventory, making the generated product listing available to other users in the future.

The customization engine may include a “human in the loop” while performing one or more customization steps. For example, the customization engine may present one or more candidate customized product suggestions generated by the brainstorm model to a human supervisor for review, modification, and/or approval before transmitting the candidate customized product suggestions to the ranking model. The customization engine may also present one or more generated machine learning model prompts to a human supervisor for review prior to transmitting the one or more prompts to their respective machine learning models. The human supervisor may also review the evaluation of a generated product listing by the approval model prior to presenting the generated product listing to the user.

One technical advantage of the disclosed techniques relative to the prior art is that the disclosed techniques leverage large language models (LLMs) and/or other generative machine learning models and multiple information types from one or more channels to automate the generation of customized product designs. The information types may include known user preferences, user purchase/viewing histories, the user's geographic location, criteria and/or standards for the customized product designs, and/or multimodal descriptive user input. The disclosed techniques sequentially execute multiple LLMs to both generate product designs and to evaluate the generated product designs, enabling a logical, stepwise progression from a textual input to a finished product design. The disclosed techniques may also iteratively present one or more generated customized product designs to a user for approval and/or feedback. Another technical advantage of the disclosed techniques is that, because customized product designs can be generated, reviewed, updated, approved, and/or made available to end users in an automatic and/or streamlined fashion, products included in search results may be more relevant to search terms and/or user preferences than products that are designed and/or created using conventional manual approaches. A further technical advantage of the disclosed techniques is that the sequential application of multiple individual LLMs allows for human review and/or approval at one or more intermediate stages of automated product design creation. This modular, stagewise configuration enables the automatic generation of product designs, while also providing visibility and oversight to the creation process. These technical advantages provide one or more improvements over prior art approaches.

1. In some embodiments, a computer-implemented method for generating customized product designs, the computer-implemented method comprises generating, via one or more machine learning models based at least on information associated with a user, candidate product data comprising (i) one or more candidate customized product suggestions, (ii) one or more product images corresponding to the one or more candidate customized product suggestions, and (iii) one or more product descriptions for the one or more candidate customized product suggestions, determining, via one or more additional machine learning models based on the candidate product data, at least a subset of the one or more candidate customized product suggestions that meets a set of evaluation criteria, and outputting the at least the subset of the one or more candidate customized product suggestions to the user.

2. The computer-implemented method of clause 1, further comprising determining at least a portion of the information associated with the user based on a search by the user, wherein the at least the subset of the one or more candidate customized product suggestions is outputted to the user in a set of search results for the search.

3. The computer-implemented method of clauses 1 or 2, wherein the search includes at least a description of a product type and a description of one or more user-specified design elements associated with the product type.

4. The computer-implemented method of any of clauses 1-3, further comprising generating a product listing associated with one of the one or more candidate customized product suggestions, and producing a customized product based at least on the product listing.

5. The computer-implemented method of any of clauses 1-4, wherein the set of evaluation criteria are based at least on one or more existing, previously approved product listings.

6. The computer-implemented method of any of clauses 1-5, wherein the set of evaluation criteria are based at least on one or more characteristics associated with a character depicted in the one or more product images.

7. The computer-implemented method of any of clauses 1-6, further comprising generating an estimated price associated with at least one of the one or more candidate customized product suggestions.

8. The computer-implemented method of any of clauses 1-7, wherein the information associated with the user includes a geographic location or region associated with the user, a history of previous product purchases made by the user, or one or more items of media content rented, purchased or viewed by the user.

9. The computer-implemented method of any of clauses 1-8, further comprising receiving, from the user, feedback associated with one or more candidate customized product suggestions, and generating, based at least on the feedback, additional candidate product data.

10.The computer-implemented method of any of clauses 1-9, further comprising presenting all or a portion of the subset of the one or more candidate customized product suggestions to a human supervisor for review prior to outputting the one or more candidate customized product suggestions to the user.

11.In some embodiments, one or more non-transitory computer-readable media store instructions that, when executed by one or more processors, cause the one or more processors to perform the steps of generating, via one or more machine learning models based at least on information associated with a user, candidate product data comprising (i) one or more candidate customized product suggestions, (ii) one or more product images corresponding to the one or more candidate customized product suggestions, and (iii) one or more product descriptions for the one or more candidate customized product suggestions, determining, via one or more additional machine learning models based on the candidate product data, at least a subset of the one or more candidate customized product suggestions that meets a set of evaluation criteria, and outputting the at least the subset of the one or more candidate customized product suggestions to the user.

12.The one or more non-transitory computer-readable media of clause 11, wherein the steps further comprise determining at least a portion of the information associated with the user based on a search by the user, wherein the at least the subset of the one or more candidate customized product suggestions is outputted to the user in a set of search results for the search.

13.The one or more non-transitory computer-readable media of clauses 11 or 12, wherein the product search query includes at least a description of a product type and a description of one or more user-specified design elements associated with the product type.

14.The one or more non-transitory computer-readable media of any of clauses 11-13, wherein the steps further comprise generating a product listing associated with one of the one or more candidate customized product suggestions, and producing a customized product based at least on the product listing.

15.The one or more non-transitory computer-readable media of any of clauses 11-14, wherein the set of evaluation criteria are based at least on one or more existing, previously approved product listings.

16.The one or more non-transitory computer-readable media of any of clauses 11-15, wherein the set of evaluation criteria are based at least on one or more characteristics associated with a character depicted in the one or more product images.

17.The one or more non-transitory computer-readable media of any of clauses 11-16, wherein the steps further comprise generating an estimated price associated with at least one of the one or more candidate customized product suggestions.

18.The one or more non-transitory computer-readable media of any of clauses 11-17, wherein the information associated with the user includes a geographic location or region associated with the user, a history of previous product purchases made by the user, or one or more items of media content rented, purchased or viewed by the user.

19.In some embodiments, a system comprises one or more memories storing instructions, and one or more processors for executing the instructions to generate, via one or more machine learning models based at least on information associated with a user, candidate product data comprising (i) one or more candidate customized product suggestions, (ii) one or more product images corresponding to the one or more candidate customized product suggestions, and (iii) one or more product descriptions for the one or more candidate customized product suggestions, determine, via one or more additional machine learning models based on the candidate product data, at least a subset of the one or more candidate customized product suggestions that meets a set of evaluation criteria, and output the at least the subset of the one or more candidate customized product suggestions to the user.

20.The system of clause 19, wherein the set of evaluation criteria are based at least on one or more characteristics associated with a character depicted in the one or more product images.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating customized product designs, the computer-implemented method comprising:
generating, via one or more machine learning models based at least on information associated with a user, candidate product data comprising (i) one or more candidate customized product suggestions, (ii) one or more product images corresponding to the one or more candidate customized product suggestions, and (iii) one or more product descriptions for the one or more candidate customized product suggestions;
determining, via one or more additional machine learning models based on the candidate product data, at least a subset of the one or more candidate customized product suggestions that meets a set of evaluation criteria; and
outputting the at least the subset of the one or more candidate customized product suggestions to the user.

2. The computer-implemented method of claim 1, further comprising determining at least a portion of the information associated with the user based on a search by the user, wherein the at least the subset of the one or more candidate customized product suggestions is outputted to the user in a set of search results for the search.

3. The computer-implemented method of claim 2, wherein the search includes at least a description of a product type and a description of one or more user-specified design elements associated with the product type.

4. The computer-implemented method of claim 1, further comprising:
generating a product listing associated with one of the one or more candidate customized product suggestions, and
producing a customized product based at least on the product listing.

5. The computer-implemented method of claim 1, wherein the set of evaluation criteria are based at least on one or more existing, previously approved product listings.

6. The computer-implemented method of claim 1, wherein the set of evaluation criteria are based at least on one or more characteristics associated with a character depicted in the one or more product images.

7. The computer-implemented method of claim 1, further comprising generating an estimated price associated with at least one of the one or more candidate customized product suggestions.

8. The computer-implemented method of claim 1, wherein the information associated with the user includes a geographic location or region associated with the user, a history of previous product purchases made by the user, or one or more items of media content rented, purchased or viewed by the user.

9. The computer-implemented method of claim 1, further comprising:
receiving, from the user, feedback associated with one or more candidate customized product suggestions; and
generating, based at least on the feedback, additional candidate product data.

10. The computer-implemented method of claim 1, further comprising presenting all or a portion of the subset of the one or more candidate customized product suggestions to a human supervisor for review prior to outputting the one or more candidate customized product suggestions to the user.

11. One or more non-transitory computer-readable media storing instructions that, when executed by one or more processors, cause the one or more processors to perform the steps of:
generating, via one or more machine learning models based at least on information associated with a user, candidate product data comprising (i) one or more candidate customized product suggestions, (ii) one or more product images corresponding to the one or more candidate customized product suggestions, and (iii) one or more product descriptions for the one or more candidate customized product suggestions;
determining, via one or more additional machine learning models based on the candidate product data, at least a subset of the one or more candidate customized product suggestions that meets a set of evaluation criteria; and
outputting the at least the subset of the one or more candidate customized product suggestions to the user.

12. The one or more non-transitory computer-readable media of claim 11, wherein the steps further comprise determining at least a portion of the information associated with the user based on a search by the user, wherein the at least the subset of the one or more candidate customized product suggestions is outputted to the user in a set of search results for the search.

13. The one or more non-transitory computer-readable media of claim 12, wherein the search includes at least a description of a product type and a description of one or more user-specified design elements associated with the product type.

14. The one or more non-transitory computer-readable media of claim 11, wherein the steps further comprise:
generating a product listing associated with one of the one or more candidate customized product suggestions, and
producing a customized product based at least on the product listing.

15. The one or more non-transitory computer-readable media of claim 11, wherein the set of evaluation criteria are based at least on one or more existing, previously approved product listings.

16. The one or more non-transitory computer-readable media of claim 11, wherein the set of evaluation criteria are based at least on one or more characteristics associated with a character depicted in the one or more product images.

17. The one or more non-transitory computer-readable media of claim 11, wherein the steps further comprise generating an estimated price associated with at least one of the one or more candidate customized product suggestions.

18. The one or more non-transitory computer-readable media of claim 11, wherein the information associated with the user includes a geographic location or region associated with the user, a history of previous product purchases made by the user, or one or more items of media content rented, purchased or viewed by the user.

19. A system comprising:
one or more memories storing instructions; and
one or more processors for executing the instructions to:
generate, via one or more machine learning models based at least on information associated with a user, candidate product data comprising (i) one or more candidate customized product suggestions, (ii) one or more product images corresponding to the one or more candidate customized product suggestions, and (iii) one or more product descriptions for the one or more candidate customized product suggestions;
determine, via one or more additional machine learning models based on the candidate product data, at least a subset of the one or more candidate customized product suggestions that meets a set of evaluation criteria; and
output the at least the subset of the one or more candidate customized product suggestions to the user.

20. The system of claim 19, wherein the set of evaluation criteria are based at least on one or more characteristics associated with a character depicted in the one or more product images.
